(19) United States
(12) Patent Application Publication
(10) Pub. No.: US 2016/0146438 A1
(43) Pub. Date: May 26, 2016

(54) LIGHTING SYSTEM WITH BASE, POLE, CONNECTOR, TRANSMITTER AND RECEIVER SYSTEM

(71) Applicant: The Pennsylvania Globe Gaslight Co., North Branford, CT (US)

(72) Inventor: Marcia LaFemina, Madison, CT (US)

(73) Assignee: The Pennsylvania Globe Gaslight Co., North Branford, CT (US)

(21) Appl. No.: 14/940,784

(22) Filed: Nov. 13, 2015

Related U.S. Application Data
(60) Provisional application No. 62/079,331, filed on Nov. 13, 2014.

(51) Int. Cl. F21V 21/02; F21V 23/06; F21V 21/10; F21V 33/00

(52) U.S. Cl. CPC F21V 21/02; F21V 33/0052; F21V 23/06; F21V 21/10

(57) ABSTRACT

A base for a lighting and surveillance system includes a housing defining an interior area. The base includes a first plurality of electrical connectors extending from a first end of the housing and in communication with an electrical system disposed in the interior area. The base includes a plurality of electrical connectors extending from a first end of the housing and in communication with the electrical system. The plurality of electrical connectors is configured for removably coupling to at least one lighting and surveillance system connection.

### CROSS REFERENCE TO RELATED APPLICATIONS

This application claims priority to provisional patent application No. 62/079,331 filed Nov. 13, 2014, the entirety of which is incorporated herein by reference.

### TECHNICAL FIELD

The present disclosure generally relates to a lighting system and more specifically to a base and pole having mechanical, electrical and signal connectors and a system of transmitters and receivers in communication with the lighting system, utilities and the surrounding environment.

### BACKGROUND

There are many types of exterior lighting systems including those mounted on poles, building structures, frames and bridges. One type of lighting system includes energy efficient lighting and a surveillance system, as described in commonly owned and copending U.S. patent application Ser. No. 14/326,011, entitled “Energy Efficient Lighting Platform and System,” filed Jul. 8, 2014, the subject matter of which is incorporated herein in its entirety. Such lighting systems include a significant amount of wiring that typically is connected to utilities in the field. The utilities typically include an electrical power supply. Connection of the utilities in the field can be complicated and time consuming.

In addition, the siting and installation of the lighting system typically requires coordination with state and town authorities, utilities and/or private entities such as universities, businesses and shopping centers depending on the location of the lighting system. Identification of and acquiring approval for the location of the lighting system is a complex task.

Accordingly, there exists a need for a system for simplifying the installation and connection of a lighting system. There also exists a need to maximize the use of the lighting system and in particular the space that the lighting system occupies in order to optimize and share the cost of the installation.

Embodiments of the invention address the foregoing needs as well as others.

### SUMMARY

According to aspects illustrated herein, there is provided a base for a lighting and surveillance system that includes a housing defining an interior area. The base includes a first plurality of electrical connectors extending from a first end of the housing and in communication with an electrical system disposed in the interior area. The base includes a plurality of electrical connectors extending from a first end of the housing and in communication with the electrical system. The plurality of electrical connectors is configured for “quick release” type removable coupling to at least one lighting and surveillance system connection.

According to aspects illustrated herein, there is provided a base for a lighting and surveillance system. The base includes a housing defining an interior area. One or more sensors are positioned in the interior area. The sensors are in communication with at least one utility system. The sensors include a sound detection sensor (e.g., gunshot sound detector and broken glass sound detector), a weather detection sensor, a radiation detection sensor, a chemical detection sensor, a temperature detection sensor, a motion detection sensor and a light detection sensor.

According to aspects illustrated herein, there is provided a base for a lighting and surveillance system. The base includes a housing defining an interior area. One or more base cell phone sites is disposed in the interior area.

There is also disclosed herein a pole for a lighting and surveillance system. The pole includes a tubular member extending along a longitudinal axis and having an outer wall. The pole includes a plurality of ribs extending outwardly from the longitudinal axis and joining the outer wall. Adjacent pairs of the plurality of ribs define a channel there between. The channels are adapted to receive one or more electrical conductors having a predetermined service use (e.g., high voltage transmission, low voltage transmission, optical signal transmission, and telecommunications signals).

The above described and other features are exemplified by the following figures and in the detailed description.

### BRIEF DESCRIPTION OF THE DRAWINGS

Referring now to the figures, which are exemplary embodiments, and wherein the like elements are numbered alike:

FIG. 1 is a schematic drawing of a plurality of lighting and surveillance systems in communication with a plurality of communications networks;

FIG. 2 is an enlarged front transparent view of the base of the lighting and surveillance systems shown in FIG. 1;

FIG. 3 is an enlarged rear transparent view of the base of the lighting and surveillance systems shown in FIG. 1;

FIG. 4 is an enlarged front transparent view of the base of the lighting and surveillance systems shown in FIG. 1, shown with a pole installed therein;

FIG. 5 is a schematic diagram of the base cell phone site according to embodiments of the present invention;

FIG. 6 is a schematic of an exemplary base cell phone site that may be employed with embodiments of the present invention;

FIG. 7 is a partial front view of the lighting and surveillance system of FIG. 1 shown with the lighting and surveillance housing removed and a connector exposed;

FIG. 7A is an enlarged view of detail of FIG. 7 showing the connector detail;

FIG. 8 is a side view of the portion of the lighting and surveillance system of FIG. 7;

FIG. 9 is an angular perspective view of the portion of the lighting and surveillance system of FIG. 7;

FIG. 10 is cross sectional view of the pole of FIG. 4 taken across line X-X;

FIG. 11 is cross sectional view of another embodiment of the pole of FIG. 4 taken across line X-X;

FIG. 12 is a perspective view of the pole of FIG. 11 shown in a telescoped condition;

FIG. 13 is an exploded side view of the base of FIG. 1 with a round pole;

FIG. 14 is an enlarged perspective view of a portion of the pole and base of FIG. 13;

FIG. 15 is a perspective view of the base of FIG. 1 with a square pole;

FIG. 16 is an enlarged perspective view of a portion of the pole and base of FIG. 15;

FIG. 17 is a sectional view of the poke and base of FIG. 16 taken across line 17-17

FIG. 18 is a top view of the pole and base of FIG. 15; and

FIG. 19 is a bottom view of the pole and base of FIG. 15.

### DETAILED DESCRIPTION

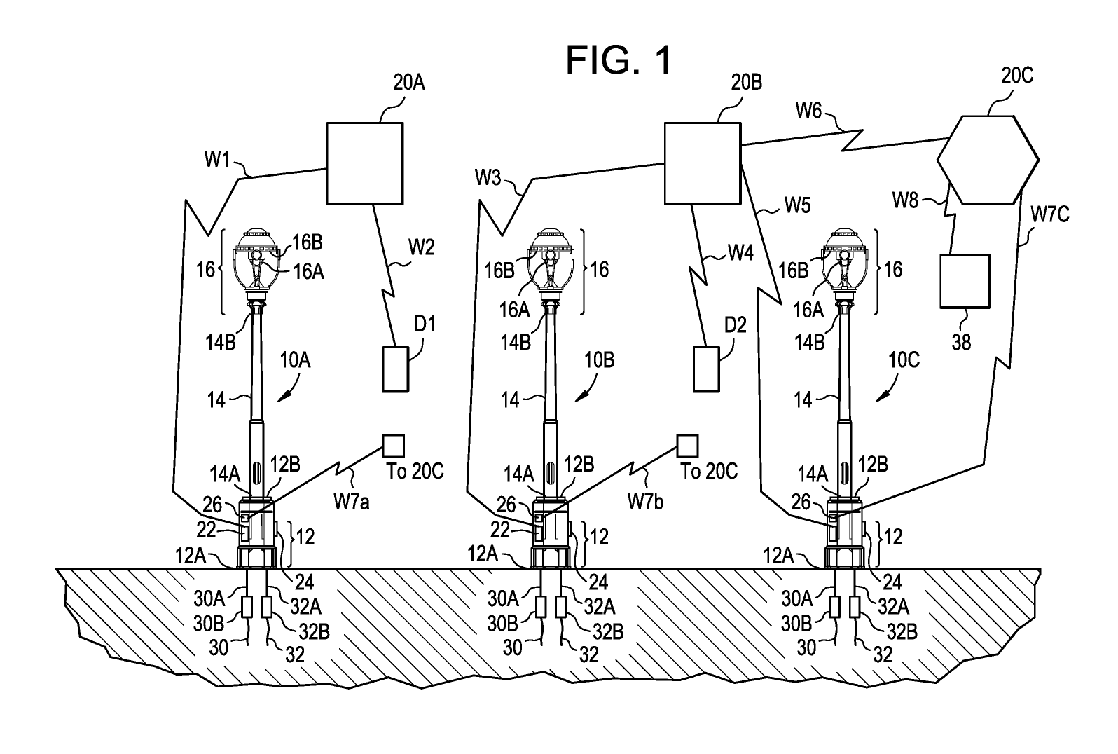

FIG. 1 illustrates a plurality of lighting and surveillance systems 10A, 10B and 10C (e.g., three are shown) in communication with a plurality of communications networks 20A, 20B and 20C (e.g., three are shown). Each of the lighting and surveillance systems 10A, 10B and 10C include a base 12. A first end 12B of the base 12 is removably secured to a first end 14A of a structural connector, for example, a pole 14. The first end 12B of the base 12 includes a plurality of pre-wired electrical connectors to facilitate “quick release” electrical connections between the base 12 and the pole 14, as described further herein. A second end 12A of the base is secured (e.g., removably secured with fasteners 59 (e.g., anchor bolts, as shown in FIG. 14) to a foundation 15, as described further herein. A second end 14B of the pole is secured to a lighting and surveillance housing 16. Each of the lighting and surveillance housings 16 include a surveillance camera 16A and a lighting system 16B, such as a LED lighting circuit board or platform. While the lighting and surveillance housings 16 are shown and described as including a surveillance camera 16A and a lighting system 16B, the present invention is not limited in this regard as the lighting and surveillance housings 16 without the camera 16A or without the lighting system 16B may be employed without departing from the broader aspects disclosed herein. In one embodiment, the pole 14 is manufactured from an aluminum alloy, for example by an extrusion method. While the pole 14 is described as being manufactured from an aluminum alloy, the present invention is not limited in this regard as other material may be employed including but not limited to alloy steel and composite plastic or polymer materials with strengthening fibers therein.

As shown in FIG. 1, each of the bases 12 include a base cell phone site 22. The base cell phone site 22 of the lighting and surveillance systems 10A is in communication with the communication network 20A via a wireless signal W1. The communication network 20A is, for example, a cell phone network server, satellite or system. The communication network 20A is in communication with a mobile device D1 via a wireless signal W2.

As shown in FIG. 1, the base cell phone site 22 of the lighting and surveillance systems 10B is in communication with the communication network 20B via a wireless signal W3. The communication network 20A is, for example, a cell phone network server or satellite system. The communication network 20B is in communication with a mobile device D2 via a wireless signal W4.

As shown in FIG. 1, the base cell phone site 22 of the lighting and surveillance systems 10C is in communication with the communication network 20B via a wireless signal W5. The communication network 20B is in communication with the communication network 20C via a wireless signal W6. The communication network 20C is, for example, an internet server. The communication network 20B is in communication with the mobile device D2 via a wireless signal W4. The communication network 20C is in communication with a surveillance monitoring system 38 via a wireless signal W8. In one embodiment, the surveillance monitoring system 38 is a security system such as for a university, a hospital, a police department, armed forces, a government entity (e.g., Homeland Security), an airport or other commercial or industrial location or campus. In one embodiment, the surveillance monitoring system 38 is a Department of Transportation traffic control and snow removal system for communication with and dispatching snow removal equipment.

As shown in FIG. 1, each of the bases 12 include a sensor platform 24 that is in communication with a CPU/transceiver 26. The CPU/transceiver 26 of the lighting and surveillance systems 10A is in communication with the communication network 20C via a wireless signal W7a. The CPU/transceiver 26 of the lighting and surveillance systems 10B is in communication with the communication network 20C via a wireless signal W7b. The CPU/transceiver 26 of the lighting and surveillance systems 10C is in communication with the communication network 20C via a wireless signal W7c.

As shown in FIG. 1, each of the bases 12 are in communication with a plurality of utility connections 30 and 32. The utility connections 30 and 32 include but are not limited to an electrical power supply, an internet connection, a fiber optic system, a telephone communications system and a cable network system. Each of the bases 12 are connected to the utility system 30 via a conductor 30A (e.g., electrical conduction fiber optic conductor or the like) and a connector 30B. Each of the bases 12 are connected to the utility system 32 via a conductor 32A (e.g., electrical conduction fiber optic conductor or the like) and a connector 32B.

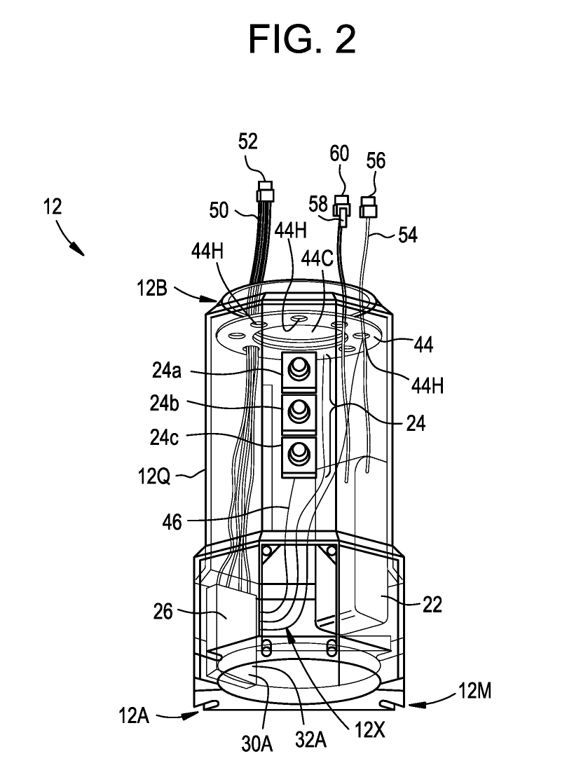

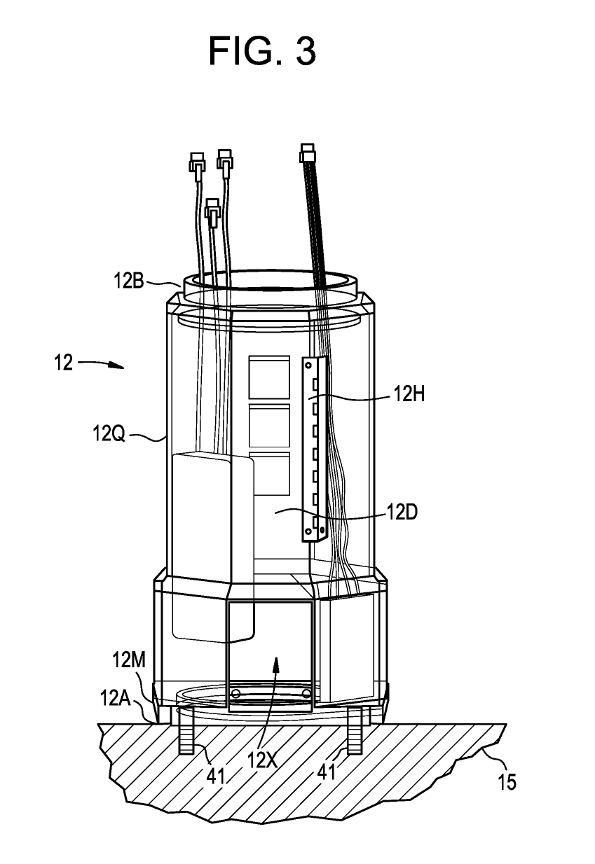

Referring to FIGS. 2-4, the base 12 is defined by a substantially cylindrical housing 12Q extending between the first end 12B and the second end 12A. A mounting platform 12M is formed in the housing 12Q proximate the second end 12A. As shown in FIG. 3, the mounting platform 12M is secured to the foundation 15 via a plurality of fasteners 41. As best shown in FIG. 3, the housing has a hinged access door 12D that is mounted to the housing 12Q via a hinge 12H. The door 12D is moveable between an open and closed position to permit access to an interior area 12X defined by the housing 12Q. The housing 12Q is manufactured from a suitable metallic material such as, but not limited to, a cast or extruded aluminum alloy. While the housing 12Q is described as being cylindrical and being manufactured from a metallic material, the present invention is not limited in this regard as the housing 12Q may be made of any material in any shape or form, including but not limited to three dimensional rectangular shapes and cubes and composite materials.

As shown in FIG. 2, the housing includes an annular ring 44 that is seated in the interior area 12X proximate the first end 12B of the housing 12Q. The annular ring 44 has a plurality of holes 44H extending therethrough. The annular ring 44 defines an interior circumferential edge 44C that is configured to receive and center the pole 14 in the housing 12Q.

As shown in FIGS. 2-4, the housing 12Q has the base cell phone site 22, sensor platform 24 and the CPU/transceiver 26 disposed therein. The sensor platform 24 is shown having three sensors 24a, 24b and 24c positioned thereon. The sensors 24a, 24b and 24c are configured to sense a plurality of attributes of the environment surrounding the lighting and surveillance systems 10A, 10B and 10C. For example, the sensors 24a, 24b and 24c employ one or more of a sound detection sensor (e.g., gunshot sound detector and broken glass sound detector), a weather detection sensor (e.g., snow fall, rain, sleet, wind, lightning or the like), a radiation detection sensor, a chemical detection sensor, a temperature detection sensor, a motion detection sensor and a light detection sensor. The sensors 24a, 24b and 24c are in communication with the CPU/transceiver 26 via a suitable conductor 46 as shown in FIG. 2. While the base cell phone site 22, sensor platform 24 and the CPU/transceiver 26 are shown and described as being disposed in the housing 12Q, the present invention is not limited in this regard as the base cell phone site 22, sensor platform 24 and/or the CPU/transceiver 26 may be positioned in the pole 14 and/or in the lighting and surveillance housings 16.

As shown in FIG. 2, the housing 12Q is “pre-wired” in that the housing 12Q includes a plurality of electrical conductors 50, 54 and 58 extending from the first end 12B of the housing 12Q out through the holes 44 H in the annular ring 44. Each of the electrical conductors 50, 54 and 58 includes a releasable connector 52, 56 and 60 (e.g., quick release connectors), respectively, secured thereto. The electrical conductor 50 is in communication with the CPU/transceiver 26 and is in communication with the lighting and surveillance housings 16 for control of pole features such as precipitation levels (e.g., snow and rain accumulations), security threats and counting mechanisms via connector 52 and connector 62 as shown in FIG. 4. The electrical conductor 54 is in communication with the CPU/transceiver 26 and is in communication with the lighting and surveillance housings 16 via connector 56 and connector 66 for control of and providing power to the lighting system 16B (e.g., LED platform). The electrical conductor 58 is in communication with the CPU/transceiver 26 and is in communication with the lighting and surveillance housings 16 via connector 60 and connector 70 for control of, providing power to and receiving signals from the surveillance camera 16A. The connectors 52, 56 and 60 are releasably secured to mating connectors 62, 66 and 70 in the pole 16, as shown in FIG. 4, for “quick release” removably coupling the housing 12Q to the lighting and surveillance system 10A, 10B or 10C. As shown in FIG. 2, the CPU/transceiver 26 is in communication with the conductor 30A for communication with the utility system 30; and the CPU/transceiver 26 is in communication with the conductor 32A for communication with the utility system 32.

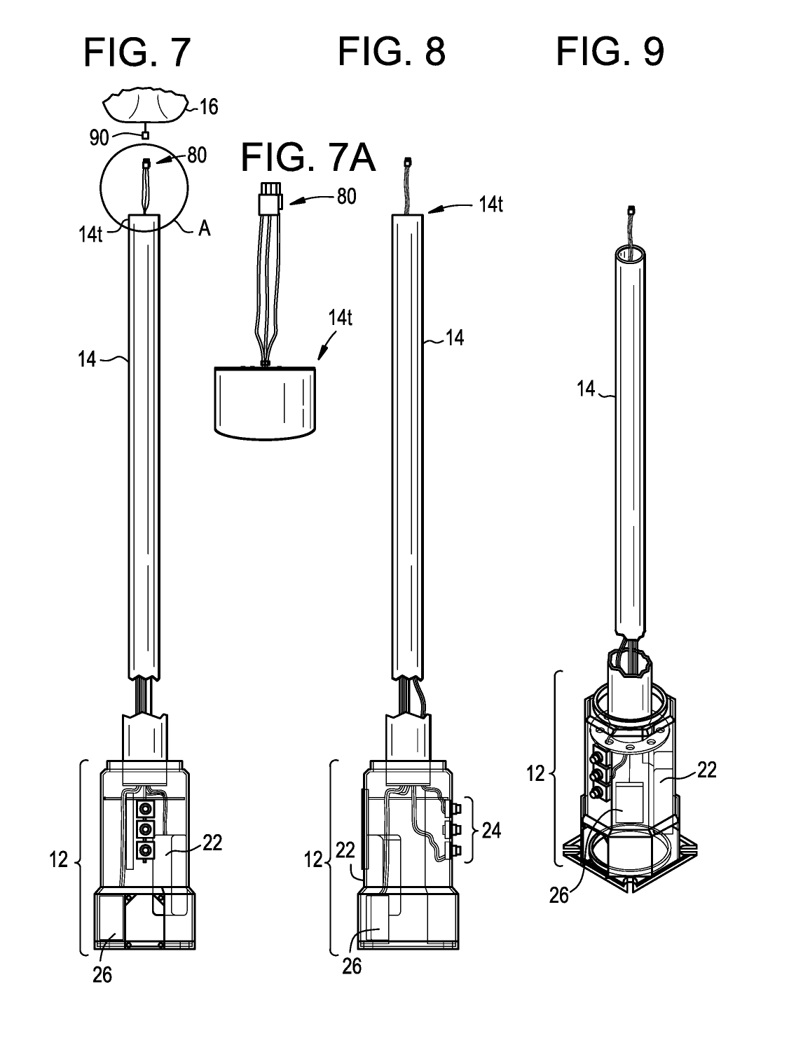

The pole 14 is mechanically coupled to the base 12 via welded aluminum platform or flange 88 (see FIG. 14). The electrical conductors 50, 54 and 58 and the connectors 52/62, 56/66 and 60/70 are located by means of a series of brackets after the pole 14 is secured to the base 12. The wiring leads are brought together by the adapting connectors 52/62, 56/66 and 60/70 which in turn are affixed to a single quick disconnect connector 80 at the end of the top 14T of the pole 14, as shown in FIGS. 7 and 7A. The disconnect connector 80 is removably coupled to a mating connector 90 extending from the lighting and surveillance housing 16.

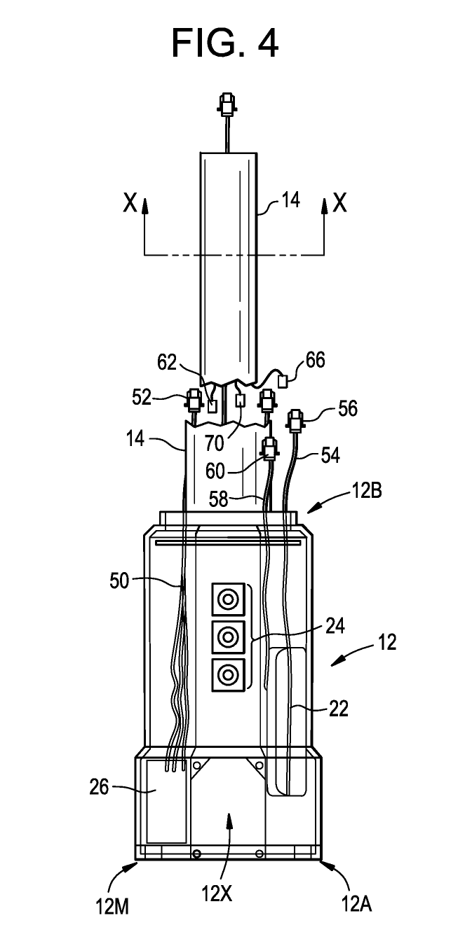

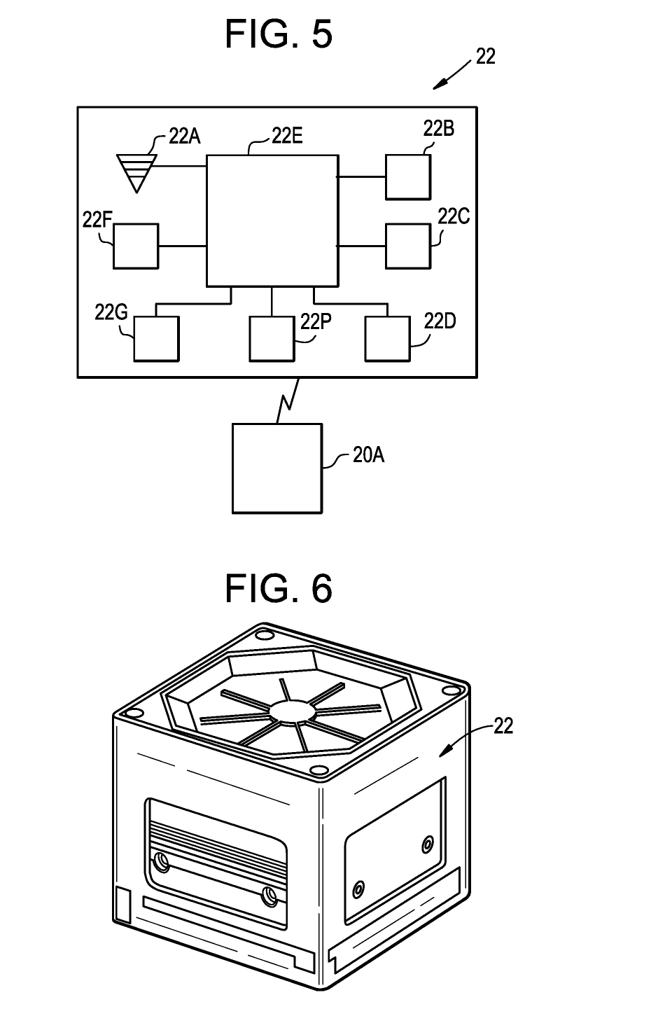

As shown in FIG. 5, the base cell phone site 22 includes one or more of an antennae 22A, a transmitter 22B, a receiver 22C, a transceiver 22D, a digital signal processor 22E, control electronics 22F, a GPS receiver 22G and an electrical power source 22P, all in communication with the digital signal processor 22E. In one embodiment, the electrical power source is a photovoltaic system. In one embodiment, the base cell phone site is a lightRadio brand base cell tower, as shown in FIG. 6 and manufactured by Alcatel-Lucent of Boulogne-Billancourt France.

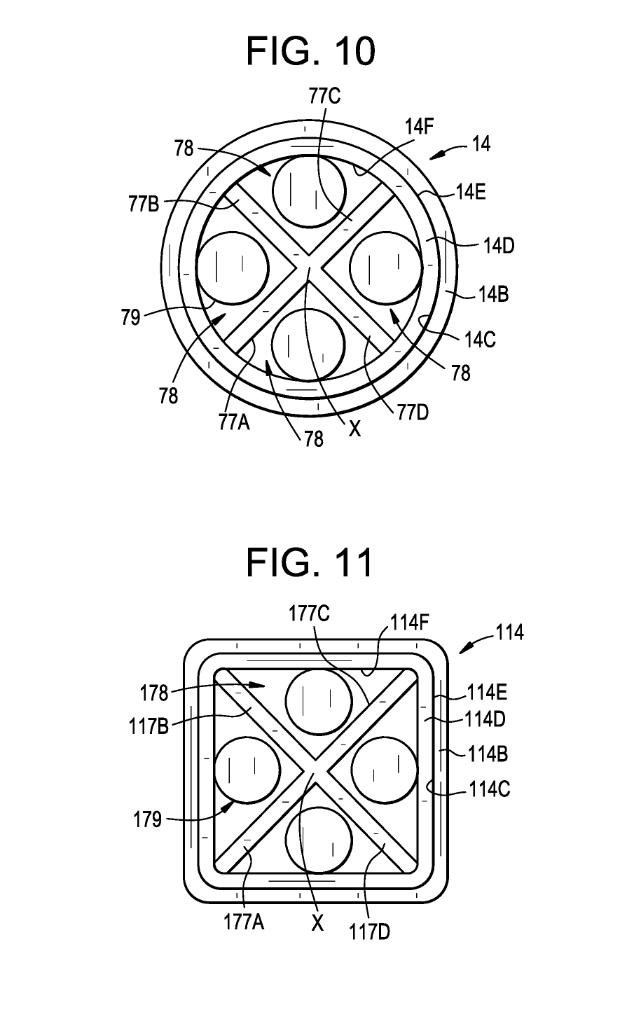

Referring to FIG. 10, in one embodiment the pole 14 has a tubular cross section (e.g., a circular cross section) and includes an outer pole section 14B that has an inner surface 14C. The pole 14 includes an inner pole section 14D that is a tubular member defined by an outer wall that has an outer surface 14E. The inner pole section 14D is telescopically (e.g., axially moveably parallel to the longitudinal axis X) positioned in the outer pole section 14B so that the inner surface 14C of the outer pole section 14B engages the outer surface 14E of the inner pole section 14D. The inner pole section 14D is selectively secured to the outer pole section 14B by a suitable fastening system (e.g., welding, threaded fasteners and/or one or pins seated in one or more holes in the inner pole section 14D and the outer pole section 14B) to establish a predetermined length of the pole 14 and defining a shoulder 14Q. The shoulder 14Q and the inner pole section 14D cooperate to receive the lighting and surveillance housing 16 thereon. In one embodiment, the inner pole section 14D and the outer pole section 14B are formed as one integral extruded piece and cooperate to define the shoulder 14Q. In one embodiment, the outer pole section 14B is eliminated and the pole 14 is defined by the inner pole section 14D.

As shown in FIG. 10, the inner pole section 14D includes four ribs 77A, 77B, 77C and 77D extending radially outward from the axis X and terminate at and are secured to an inner surface 14F of the inner pole section 14D. The ribs 77A, 77B, 77C and 77D are connected to one another at the axis X. In one embodiment, the inner pole section 14D with the ribs 77A, 77B, 77C and 77D therein is a monolithic piece that is manufactured by an extrusion process. For example, the inner pole section 14D with the ribs 77A, 77B, 77C and 77D therein is an aluminum alloy extrusion. The ribs 77A, 77B, 77C and 77D provide strength to the inner pole section 14D for resistance to bending.

As shown in FIG. 10 adjacent pairs of the ribs 77A, 77B, 77C and 77D define a channel 78 therebetween. The channel 78 is adapted to receive one or more of the electrical conductors 50, 54 and 58 or a conduit 79 therein. The channels 78 are adapted to accommodate and segregate electrical conductors of different voltages. For example, high voltage conductors may be accommodated in one channel 78; low voltage conductors may be accommodated in another channel 78; telecommunications conductors may be accommodated in another channel 78, fiber optics conductors may be accommodated in another channel 78; and other conductors may be accommodated in another of the channels 78. In one embodiment, each of the channels 78 is configured to have minimum cross sectional area of 1.43 square inches.

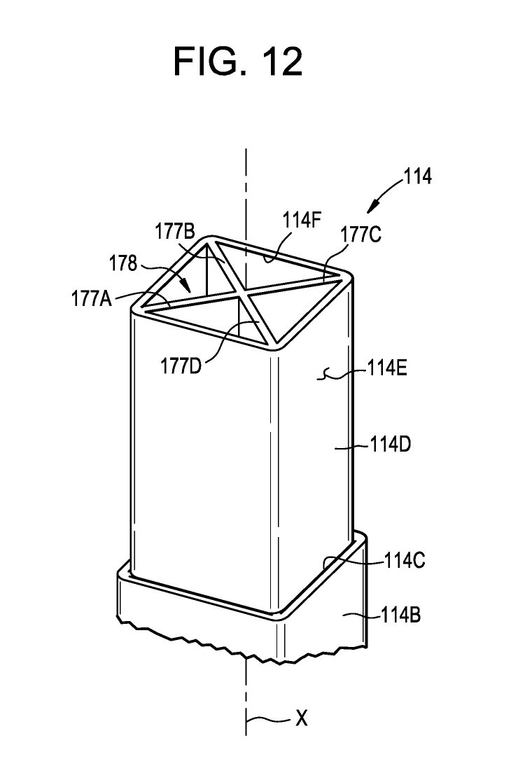

FIGS. 11 and 12 illustrate a pole 114 similar to the pole of FIG. 10 except that instead of having a circular cross section the pole 114 has a square cross section. While the pole 114 is shown and described as having a square cross section, the present invention is not limited in this regard as the pole 114 may have any cross section including rectangular, triangular or oval. The pole 114 includes an outer pole section 114B that has an inner surface 114C. The pole 114 includes an inner pole section 114D that is a tubular member that has an outer surface 114E. The inner pole section 114D is telescopically (e.g., axially moveably parallel to the axis X) positioned in the outer pole section 114B so that the inner surface 114C of the outer pole section 114B engages the outer surface 114E of the inner pole section 114D. The inner pole section 114D is selectively secured to the outer pole section 114B by a suitable fastening system (e.g., welding, threaded fasteners and/or one or pins seated in one or more holes in the inner pole section 114D and the outer pole section 114B) to establish a predetermined length of the pole 114 and defining a shoulder 114Q. The shoulder 114Q and the inner pole section 114D cooperate to receive the lighting and surveillance housing 16 thereon. In one embodiment, the inner pole section 114D and the outer pole section 114B are formed as one integral extruded piece and cooperate to define the shoulder 114Q. In one embodiment, the outer pole section 114B is eliminated and the pole 114 is defined by the inner pole section 114D.

As shown in FIGS. 11 and 12, the inner pole section 114C includes four ribs 177A, 177B, 177C and 177D extending radially outward from the axis X and terminate at and are secured to an inner surface 114F of the inner pole section 114D. The ribs 177A, 177B, 177C and 177D are connected to one another at the axis X. In one embodiment, the inner pole section 114D with the ribs 177A, 177B, 177C and 177D therein is a monolithic piece that is manufactured by an extrusion process. For example, the inner pole section 114D with the ribs 177A, 177B, 177C and 177D therein is an aluminum alloy extrusion. The ribs 177A, 177B, 177C and 177D provide strength to the inner pole section 114D for resistance to bending.

As shown in FIGS. 11 and 12 adjacent pairs of the ribs 177A, 177B, 177C and 177D define a channel 718 therebetween. The channel 178 is adapted to receive one or more of the electrical conductors 50, 54 and 58 or a conduit 179 therein, similar to that described above for the channels 78. In one embodiment, each of the channels 178 is configured to have minimum cross sectional area of 1.92 square inches.

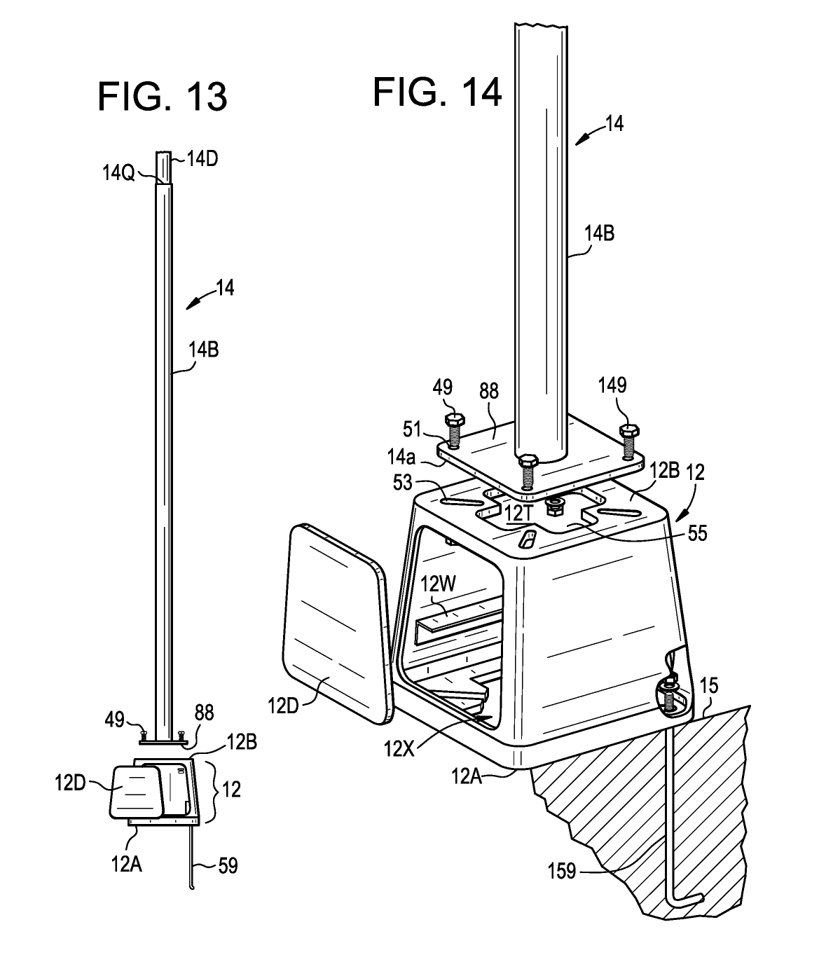

Referring to FIGS. 13 and 14 a lower end of the pole 14 has a mounting flange 88 secured thereto, for example, by welding or threading on to the pole 14. The flange 88 includes a plurality of holes 51 (e.g., four holes are shown) extending therethrough. A fastener 49 (e.g., a bolt) is fitted through each of the holes 51 and further through a respective elongate opening 53 in the first end 12B of the base 12. A nut 55 is threaded onto the bolt 49 to removably secure the flange 88 to the first end of the base 12. The first end 12B of the base 12 has an opening 12T therein which communicates with the interior area 12X of the base 12. The opening 12T is adapted to receive the electrical conductors 50, 54 and 58 shown in FIG. 2 therethrough and extend into the channels 78 of the pole 14. As shown in FIG. 14 shelves 12W are provided in the interior area 12X of the base 12 for receiving electronic devices (not shown) such as circuit boards, connector plates, transmitters and receivers.

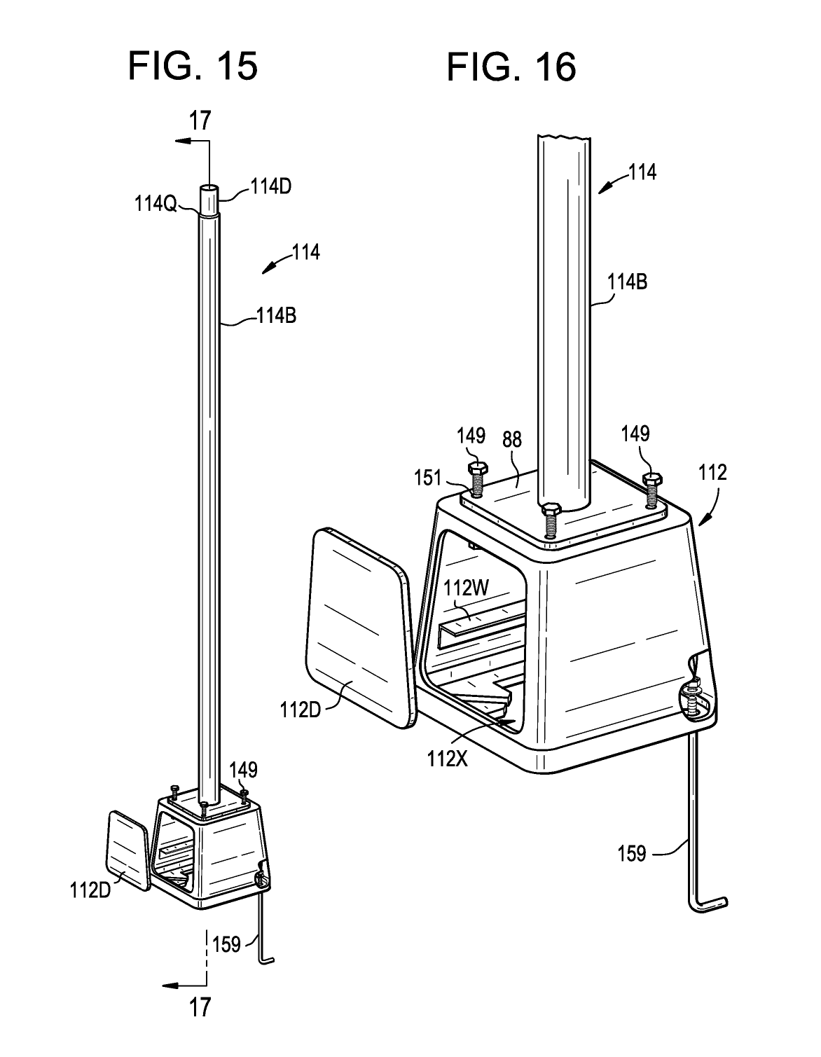

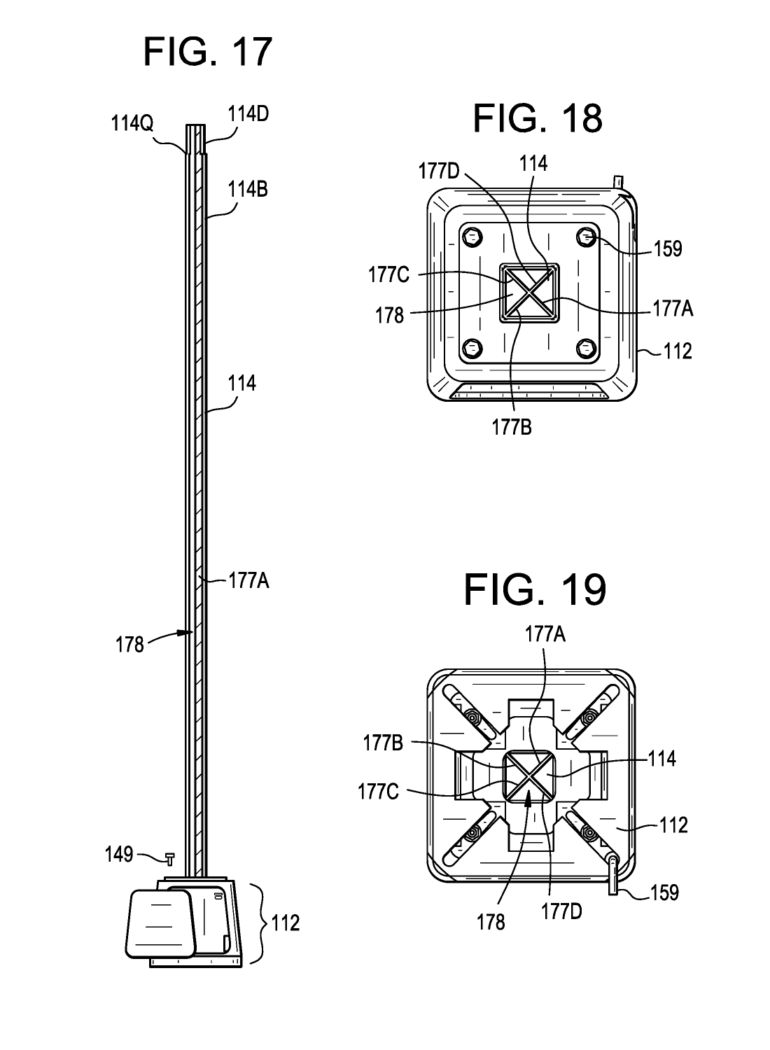

FIGS. 15, 16 and 17 illustrate a pole 114 and base 112 similar to that described above with reference to FIGS. 10, 13 and 15, with the exception that the pole 114 is a square pole as illustrated in FIGS. 11 and 12. Thus, similar components are marked with corresponding element numbers preceded by the numeral 1. FIG. 18 illustrates a top view of the pole 114 and base 112 of FIG. 16; and FIG. 19 illustrates a bottom view of the pole 114 and base 112 of FIG. 16.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

Moreover, it is noted that the features and elements described herein can be employed in any combination with other features and/or elements, embodiments and so forth described herein.

What is claimed is:

1. A base for a lighting and surveillance system, the base comprising:
a housing defining an interior area; and
a first plurality of electrical connectors extending from a first end of the housing and in communication with an electrical system, the first plurality of electrical connectors being configured for removably coupling to at least one lighting and surveillance system connection.

2. The base of claim 1, further comprising:
a second plurality of electrical connectors extending from a second end of the housing and in communication with the electrical system disposed in the interior area, the second plurality of electrical connectors being configured for removably coupling to at least one utility connection.

3. The base of claim 2, further comprising:
at least one mechanical fastener proximate the second end of the housing, for securing the housing to a structure; and
a mechanical coupling proximate the first end of the housing, for removably securing the lighting and surveillance system to the housing.

4. The base of claim 1, further comprising:
at least one sensor positioned in the interior area, the at least one sensor being in communication with at least one utility.

5. The base of claim 4, wherein the at least one sensor comprises at least one of a sound detection sensor, a weather detection sensor, a radiation detection sensor, a chemical detection sensor, a temperature detection sensor, a motion detection sensor and a light detection sensor.

6. The base of claim 1, further comprising at least one base cell phone site.

7. The base of claim 6, wherein the at least one base cell phone site comprises at least one of an antennae, a transmitter, a receiver, a transceiver, a digital signal processor, control electronics, a GPS receiver and an electrical power source.

8. The base of claim 7, wherein the electrical power source comprises a photovoltaic system.

9. A base for a lighting and surveillance system, the base comprising:
a housing defining an interior area; and
at least one sensor positioned in the interior area, the at least one sensor being in communication with at least one utility.

10. The base of claim 9, further comprising:
at least one mechanical fastener proximate a second end of the housing, for securing the housing to a structure; and
a mechanical coupling proximate a first end of the housing, for removably securing the lighting and surveillance system to the housing.

11. The base of claim 9, wherein the at least one sensor comprises at least one of a sound detection sensor, a weather detection sensor, a radiation detection sensor, a chemical detection sensor, a temperature detection sensor, a motion detection sensor and a light detection sensor.

12. The base of claim 8, at least one base cell phone site.

13. The base of claim 12, wherein the at least one base cell phone site comprises at least one of an antennae, a transmitter, a receiver, a transceiver, a digital signal processor, control electronics, a GPS receiver and an electrical power source.

14. The base of claim 13, wherein the electrical power source comprises a photovoltaic system.

15. The base of claim 9, further comprising:
a first plurality of electrical connectors extending from a first end of the housing and in communication with an electrical system, the first plurality of electrical connectors being configured for removably coupling to at least one lighting and surveillance system connection.

16. The base of claim 9, further comprising:
a second plurality of electrical connectors extending from a second end of the housing and in communication with an electrical system disposed in the interior area, the second plurality of electrical connectors being configured for removable coupling to at least one utility connection.

17. A base for a lighting and surveillance system, the base comprising:
a housing defining an interior area; and
at least one base cell phone site.

18. The base of claim 17, wherein the at least one base cell phone site comprises at least one of an antennae, a transmitter, a receiver, a transceiver, a digital signal processor, control electronics, a GPS receiver and an electrical power source.

19. The base of claim 18, wherein the electrical power source comprises a photovoltaic system.

20. The base of claim 17, further comprising:
a first plurality of electrical connectors extending from a first end of the housing and in communication with an electrical system, the first plurality of electrical connectors being configured for removable coupling to at least one lighting and surveillance system connection.

21. The base of claim 17, further comprising:
a second plurality of electrical connectors extending from a second end of the housing and in communication with an electrical system disposed in the interior area, the second plurality of electrical connectors being configured for removable coupling to at least one utility connection.

22. The base of claim 17, further comprising:
at least one mechanical fastener proximate a first end of the housing, for securing the housing to a structure; and
a mechanical coupling proximate a second end of the housing, for removably securing the lighting and surveillance system to the housing.

23. The base of claim 17, further comprising:
at least one sensor positioned in the interior area, the at least one sensor being in communication with at least one utility.

24. The base of claim 23 wherein the at least one sensor comprises at least one of a sound detection sensor, a weather detection sensor, a radiation detection sensor, a chemical detection sensor, a temperature detection sensor, a motion detection sensor and a light detection sensor.

25. A pole for a lighting and surveillance system, the pole comprising:
a tubular member extending along a longitudinal axis and having an outer wall;
a plurality of ribs extending outwardly from the longitudinal axis and joining the outer wall; and
adjacent pairs of the plurality of ribs defining a channel there between; and
wherein the channels are adapted to receive an electrical conductor.
